(19) United States
(12) Patent Application Publication
(10) Pub. No.: US 2005/0236534 A1
(43) Pub. Date: Oct. 27, 2005

(54) Telescopic device

(76) Inventor: Ole Bondesen, Sünderborg (DK)

Correspondence Address: HARNESS, DICKEY & PIERCE, P.L.C., P.O. BOX 8910, RESTON, VA, 20195, US

(21) Appl. No.: 11/113,136

(22) Filed: Apr. 25, 2005

(30) Foreign Application Priority Data
Apr. 26, 2004 (SE) 0401060-9

(51) Int. Cl. F16M 11/00

(52) U.S. Cl. 248/161

(57) ABSTRACT

A telescopic device (1) has three telescopic segments, viz. an outer segment (2), an intermediate segment (4) and an inner segment (6). The inner segment (6) is arranged to be telescoped in the intermediate segment (4) by a first shifting device (8), the intermediate segment (4) in turn being arranged to be telescoped in the outer segment (2) by a second shifting device (10). The first and the second shifting device (8, 10) are mechanically connected to each other by a transmission connection (46) in such a manner that activation of one of the shifting devices (8; 10) causes simultaneous activation also of the other shifting device (10; 8) and simultaneous telescoping of the intermediate segment (4) in relation to the outer segment (2) and of the inner segment (6) in relation to the intermediate segment (4).

### TECHNICAL FIELD

The present invention relates to a telescopic device having three telescopic segments, viz. an outer segment, an intermediate segment and an inner segment, which inner segment is arranged to be telescoped in the intermediate segment by a first shifting device, the intermediate segment in turn being arranged to be telescoped in the outer segment by a second shifting device.

### BACKGROUND ART

Telescopic devices of the above type are often used for raising and lowering, for instance, desks, control room desks, beds, examination tables, dental chairs, ceiling light fittings etc. The telescopic movement of the telescopic device is provided by means of screws, chains or hydraulic pistons or using some other prior-art means. All known methods of telescoping segments in relation to each other have the drawback that it is relatively difficult to keep a check on in which telescoping position the different segments are positioned relative to each other. This may result in, for instance, the inner segment reaching a completely extended position before the intermediate segment reaches the corresponding position, which may cause a reduction of the stability of the telescopic device in certain phases of the telescoping. The electronic control systems that have been used until now to overcome these problems are expensive and complicated.

### SUMMARY OF THE INVENTION

The object of the present invention is to provide a telescopic device which eliminates the problems of prior-art technique, and thus to provide a telescopic device which effectively provides check on the position of the three segments while telescoping them in relation to each other.

This object is achieved by a telescopic device which is of the type stated by way of introduction and characterised in that the first shifting device comprises a threaded first rod and a first nut movable along the same, and the second shifting device comprises a threaded second rod and a second nut movable along the same, the first and the second shifting device being mechanically connected to each other by a transmission connection being placed in one of the segments, the transmission connection being adapted to rotate one of the first rod and the first nut and simultaneously one of the second rod and the second nut, the other of the first rod and the first nut, and the other of the second rod and the second nut each being fixedly connected to a segment separate from that segment in which the transmission connection is placed, the activation of one of the shifting devices causing simultaneous activation also of the other shifting device and simultaneous telescoping of the intermediate segment in relation to the outer segment and of the inner segment in relation to the intermediate segment. An advantage of this device is that a complete check on how the segments move relative to each other, and when, is provided without having to use advanced electronic control. The movement of the segments will be even and without jerkiness, which reduces the mechanical load on the shifting devices and also gives a reliable impression to a person watching the movement. The invention also makes it possible to drive the telescopic device by a single motor. Alternatively, a plurality of motors can be used, which then require only one motor control. A special advantage is that the telescopic device provides a high security level since, if one shifting device has got locked, for instance because the inner segment cannot be extended, also the other shifting device will be locked mechanically and no telescoping at all may take place.

The first shifting device suitably comprises a threaded first rod and a first nut movable along the same, and the second shifting device comprises a threaded second rod and a second nut movable along the same. The use of threaded rods gives the segments a very even and well-controlled telescopic movement at a low sound level.

According to a preferred embodiment, the first rod is rotatably but axially non-displaceably connected to the intermediate segment and the first nut is fixedly connected to the inner segment, the second rod being fixedly connected to the outer segment and the second nut being rotatably but axially non-displaceably connected to the intermediate segment. An advantage of this is that, when the rotating parts, the first rod and the second nut, are rotatably attached to the intermediate segment, the shifting devices will have a very small total height when the telescopic device is located in its most retracted telescoping position. As a result, the telescopic device will have a small height in the retracted telescoping position, but can be expanded to a very great height in relation to the height of the segments in its maximally extended telescoping position. A telescopic device thus is provided, which has a very small mounting dimension relative to its maximum stroke.

According to a preferred embodiment, the transmission connection comprises a first gear rim fixedly connected to the first rod and a second gear rim fixedly connected to the second nut, the first and the second gear rim being arranged to be driven by a common motor. Gear rims have the advantage that they do not slip but give a safe and reliable transmission of the rotary motion so that a full check on the relative position of the segments is provided.

The first and the second gear rim are suitably in tooth engagement with each other, the motor being arranged to drive one of said gear rims. An advantage of this is that the transmission connection will be compact and have small transmission losses. In addition, the first rod and the second rod may be formed with threads that have the same direction.

According to a preferred embodiment, at least two motors are arranged to drive the transmission connection. An advantage of this is that redundancy can be achieved. Thus, if a first motor has broken down, a second motor can manage to drive both the first and the second shifting device, and the telescopic device can still reach its most retracted as well as its maximally extended telescoping position. If motors with an integrated brake are used, the transmission connection will give a redundancy also for the braking effect, which increases safety. If the brake of one motor breaks down, the brake of the other motor will, thanks to the transmission connection, brake both shifting devices so that no undesirable, quick retraction, or extension, of the telescopic device occurs. An example of an application where this is advantageous is when the telescopic device is mounted as a column under an examination or operation table and, under no circumstances, is allowed to be compressed unintentionally, during surgery for instance, owing to breakdown of a motor or its brake.

According to an alternative embodiment the telescopic device has at least one slave segment, which is arranged between the inner segment and the intermediate segment or between the intermediate segment and the outer segment, said slave segment being arranged to be driven by the segment on the outside of which it is arranged. An advantage of this embodiment is that the telescopic device withstands greater loads in the lateral direction.

According to a preferred embodiment, the transmission connection has such a gear ratio that the intermediate segment will be telescoped in relation to the outer segment at the same speed at which the inner segment will be telescoped in relation to the intermediate segment. An advantage of this embodiment is that the inner segment and the intermediate segment will always have the same extended position in relation to the intermediate segment and, respectively, in relation to the outer segment and always have the same speed of extension. From the point of view of strength as well as from the aesthetic point of view, this movement pattern is often preferred.

Further advantages and features of the invention will appear from the following description and the appended claims.

### BRIEF DESCRIPTION OF THE DRAWINGS

The present invention will now be described in more detail with reference to the accompanying drawings.

FIG. 1 is a top plan view of a telescopic device according to the invention.

FIG. 2 is a sectional view of the telescopic device shown in FIG. 1, seen in the section II-II in a first telescoping position.

FIG. 3 is a sectional view of the telescopic device shown in FIG. 1 in the section III-III in the first telescoping position.

FIG. 4 is a perspective view of shifting devices included in the telescopic device, seen obliquely from above and in the first telescoping position.

FIG. 5 is a perspective view of a transmission connection included in the telescopic device.

FIG. 6 is a sectional view of the transmission connection, seen in the section VI-VI in FIG. 2.

FIG. 7 is a sectional view, illustrating the section shown in FIG. 2 but in a second telescoping position.

FIG. 8a is a side view of the telescopic device shown in FIG. 1 in a third telescoping position.

FIG. 8b is a sectional view of the telescopic device in the third telescoping position in the section shown in FIG. 2.

FIG. 9 is a perspective view of the shifting devices included in the telescopic device, seen obliquely from above and in an almost completely extended telescoping position.

FIG. 10 is a perspective view of an actuator for a telescopic device according to an alternative embodiment.

FIG. 11 is a cross-sectional view of a transmission connection included in the actuator in FIG. 10, seen in the section XI-XI.

FIG. 12a is a perspective view of an actuator for a telescopic device according to another alternative embodiment.

FIG. 12b is a cross-section of a shifting device included in the actuator in FIG. 12a, seen in the section XII-XII.

FIG. 13 is a cross-sectional view and shows the schematic principle of a telescopic device according to yet another embodiment of the invention.

FIG. 14 is a cross-sectional view of the telescopic device shown in FIG. 13 in a more extended telescoping position.

### DETAILED DESCRIPTION OF PREFERRED EMBODIMENTS

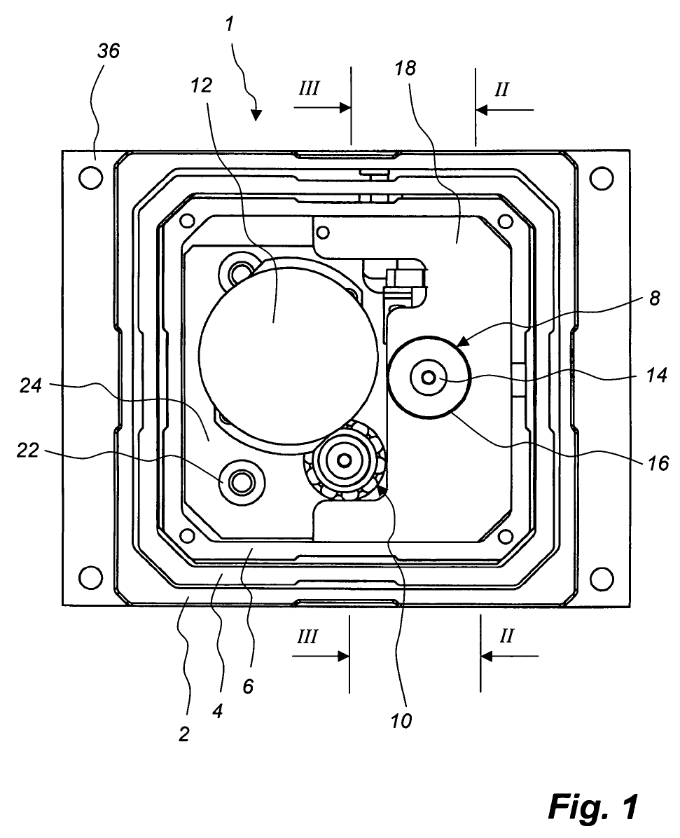

FIG. 1 is a top plan view of a telescopic device 1, which is adapted to be used as a telescopic column for raising and lowering of tables, treatment chairs, beds and the like. The telescopic device 1 has an outer segment 2, an intermediate segment 4 arranged inside the same and an inner segment 6 arranged inside the intermediate segment 4. The inner segment 6 is arranged to be telescoped in relation to the intermediate segment 4 by a first shifting device 8. The intermediate segment 4 is in turn arranged to be telescoped in relation to the outer segment 2 by a second shifting device 10. A common motor 12 is arranged to simultaneously drive the first shifting device 8 and the second shifting device 10 in a manner that will be explained in more detail below.

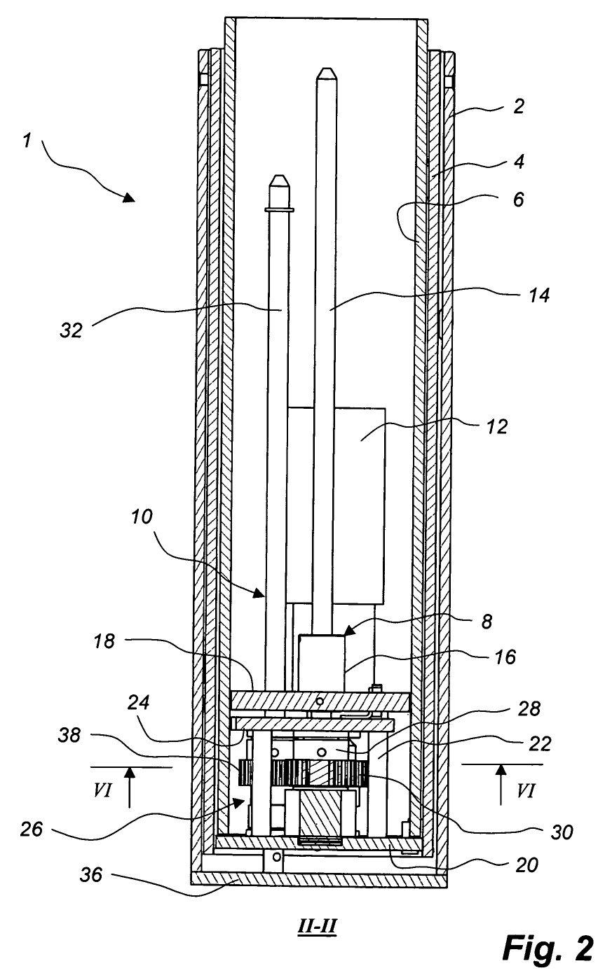

The first shifting device 8 has a threaded first rod 14, which is arranged to rotate inside a first nut 16 which is included in the shifting device 8 and which can be, for example, a threaded nut or a ball nut. The thread can be, for instance, a trapezoidal thread, a ball nut thread or some other suitable type of thread. The nut 16 is fixedly connected to a mounting plate 18 which is attached to the lower portion of the inner segment 6, which is also shown in FIG. 2. A base plate 20 is attached to the lower portion of the intermediate segment 4. The base plate 20 supports by means of four struts 22, of which only two are shown in FIG. 2, a motor plate 24, to which the motor 12 is attached and which together with the base plate 20 forms a transmission case 26 attached to the intermediate segment 4. The first rod 14 is, by means of a first shaft 28, to which the rod 14 is fixedly connected, mounted in bearings in the base plate 20 and the motor plate 24 and is thus rotatable, but not displaceable in the axial direction in relation to the transmission case 26 and, thus, also not displaceable in relation to the intermediate segment 4. A first gear rim 30 is fixedly connected to the first shaft 28 and extends around the same.

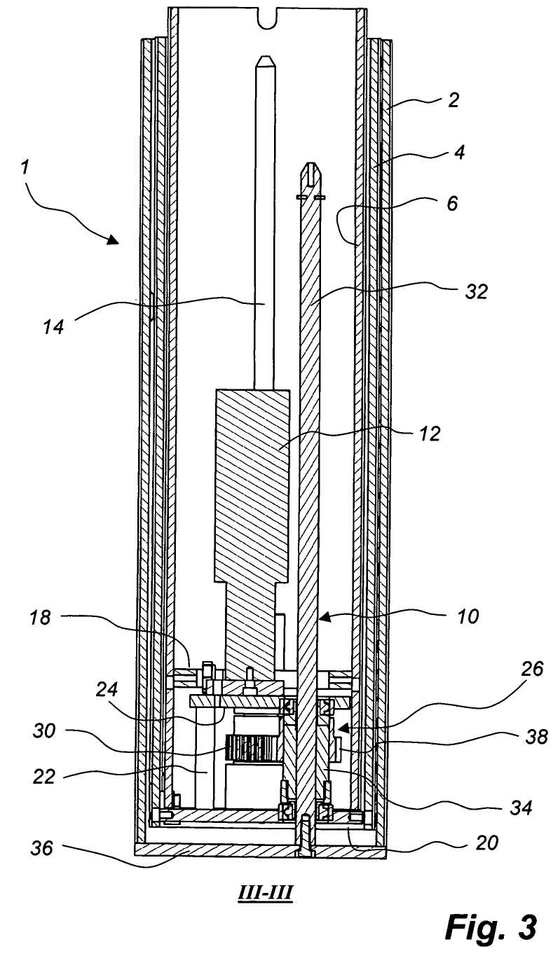

FIG. 3 shows in more detail the second shifting device 10. The second shifting device 10 has a threaded second rod 32 on which a second nut 34, which, for instance, can be a threaded nut or a ball nut, is arranged to rotate. The second rod 32 is fixedly connected to a supporting plate 36 which is attached to the lower part of the outer segment 2. The second rod 32 can thus neither rotate nor be displaced in any direction. The second nut 34 is rotatably mounted in bearings in the base plate 20 and the motor plate 24 and thus is rotatable, but not displaceable in the axial direction in relation to the transmission case 26 and thus is not displaceable in relation to the intermediate segment 4 either. A second gear rim 38 which is fixedly connected to the nut 34 extends around the second nut 34.

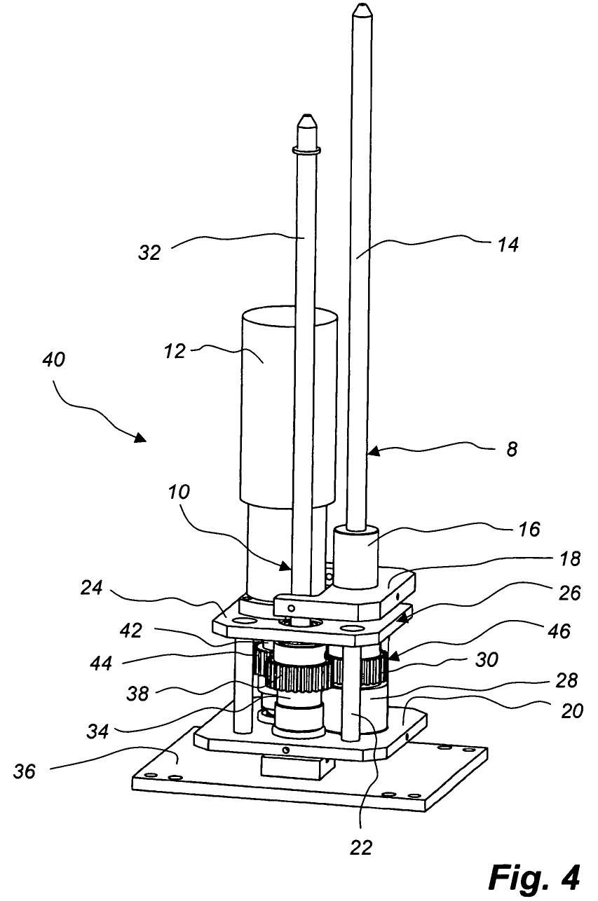

FIG. 4 shows the first shifting device 8, the second shifting device 10, the motor 12 and the transmission case 26 which together form the actuator 40 of the telescopic device 1, before mounting in the segments 2, 4, 6. FIGS. 1-4 illustrate the first telescoping position where the telescopic device 1 is in its shortest position, i.e. in its most retracted telescoping position. As is evident from FIG. 4, the base plate 20, which is arranged to be attached to the intermediate segment 4, is in this position located very close to the supporting plate 36, which is arranged to be attached to the outer segment 2. The motor plate 24 is positioned very close to the mounting plate 18, which is arranged to be attached to the inner segment 6. In this position, the actuator 40 of the telescopic device 1 thus is very compact, which on the one hand contributes to low transport costs and, on the other, allows the telescopic device 1 in this first extended position to be given a height which only slightly exceeds the height of an individual segment 2, 4, 6 and still allow the telescopic device 1 to be extended to a great maximum height, as will also be evident from the following description. FIG. 4 also shows a second shaft 42 to which the motor 12 is connected. A third gear rim 44 extends around the second shaft 42. The gear rims 30, 38 and 44 are included in the transmission connection 46 of the actuator 40.

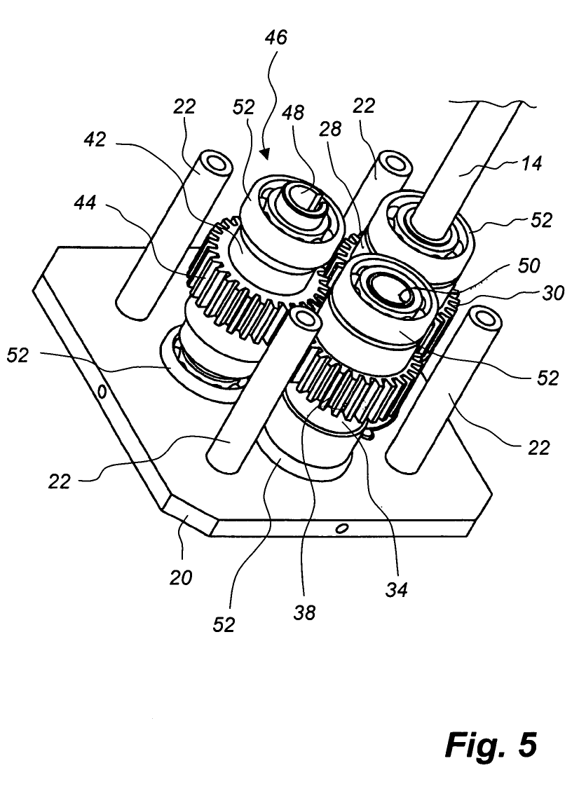

FIG. 5 shows more distinctly the transmission connection 46. In FIG. 5, the motor plate 24 and the motor 12 have been dismounted for the sake of clarity. The transmission connection 46 comprises the first shaft 28 included in the first shifting device 8 and the first gear rim 30 attached to the first shaft, the nut 34 which is included in the second shifting device 10 and the second gear rim 38 attached to said nut, and the second shaft 42 and the third gear rim 44 attached thereto. The second shaft 42 is provided with a motor connection 48 which is adapted to be connected to an output shaft of the current type of motor 12. The second nut 34 has an opening 50 in which the second rod 32 can run. The shafts 28, 42 and the nut 34 are mounted in the base plate 20 and the motor plate (not shown in FIG. 5) by ball bearings 52. The third gear rim 44 is in tooth engagement with the second gear rim 38, which in turn is in tooth engagement with the first gear rim 30.

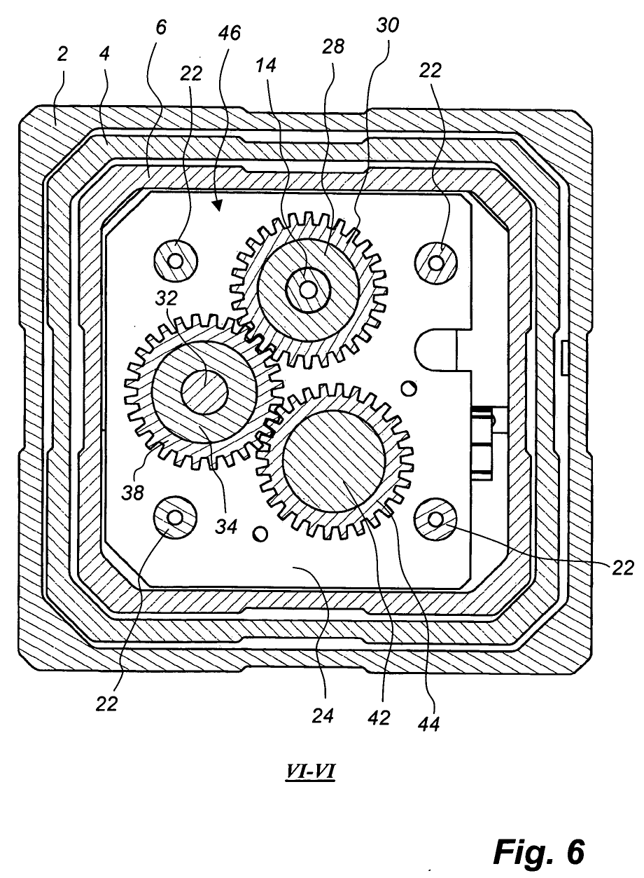

FIG. 6 is a cross-section through the transmission connection 46 and distinctly shows the function thereof. When the motor 12 is activated, it will rotate the shaft 42 and, thus, the third gear rim 44. The third gear rim 44 transmits the rotation to the second gear rim 38 and thus makes the second nut 34 rotate. When the second nut 34 rotates, it will climb upwards along the threaded second rod 32 which is attached to the supporting plate 36. By the nut 34 being mounted in bearings in the transmission case 26, which is attached to the intermediate segment 4, the entire intermediate segment 4 will be telescoped upwards in relation to the outer segment 2. The second gear rim 38 at the same time transmits the rotation of the shaft 42 to the first gear rim 30. The first gear rim 30 will rotate the shaft 28 and, thus, the threaded first rod 14. When the first rod 14 rotates inside the first nut 16, which is attached to the mounting plate 18 and cannot rotate, the first nut 16 will be forced to climb upwards along the first rod 14. By the plate 18 being attached to the inner segment 6, the inner segment 6 will thus be telescoped upwards. Thus, the motor 12 will, when activated, at the same time drive the first shifting device 8, which consequently telescopes the inner segment 6 in relation to the intermediate segment 4, and the second shifting device 10, which consequently telescopes the intermediate segment 4 in relation to the outer segment 2.

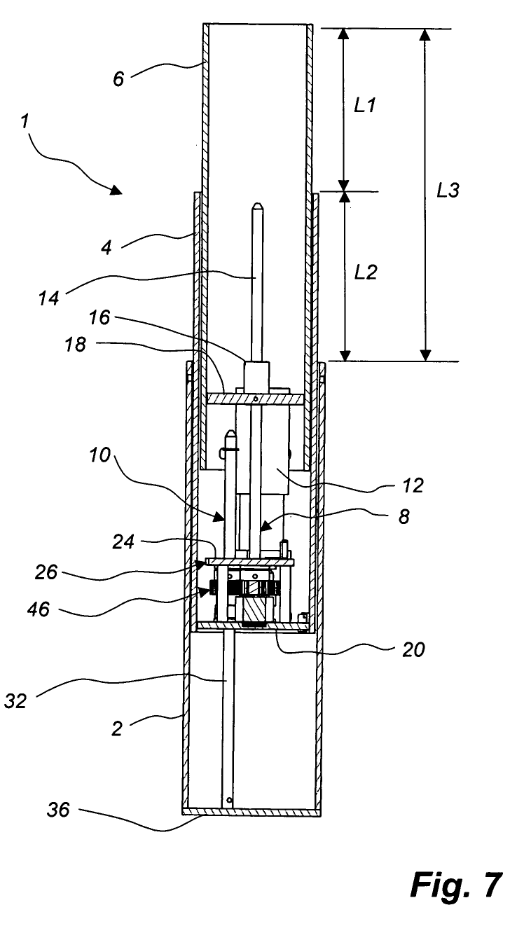

FIG. 7 illustrates the appearance of the telescopic device 1 when the motor 12 has been activated for a while. As indicated in FIG. 6, the first gear rim 30 has the same number of teeth as the second gear rim 38, which means that the gear ratio in the transmission connection 46, in this embodiment, is 1:1 between the first rod 14 and the second nut 34. Moreover the first rod 14 has a thread, which has the same pitch as the thread of the second rod 32. All in all, this means that the inner segment 6 will be telescoped in relation to the intermediate segment 4 at the same speed at which the intermediate segment 4 will be telescoped in relation to the outer segment 2. In the position shown in FIG. 7, after the motor 12 has been in operation for a time t1, the inner segment 6 has been telescoped a distance L1 in relation to the intermediate segment 4 (as is evident from FIG. 2, the inner segment 6, even in the completely retracted telescoping position, projects somewhat at its upper end for the purpose of facilitating the mounting of, for example, a table on the telescopic device 1). At the same time, the intermediate segment 4 has been telescoped a distance L2 in relation to the outer segment 2. Since the gear ratio of the transmission connection 46 in the shown embodiment is 1:1 as stated above and the threads of the rods 14 and 32 have the same pitch, L1 will be exactly the same as L2. As is evident from FIG. 7, the inner segment 6 has been telescoped a distance L1+L2=L3 from the outer segment 2. Thus during the time t1, a single motor 12 has provided a total extension of the telescopic device 1 that corresponds to the length L3 thanks to the fact that the two shifting devices 8, 10 are driven simultaneously and each act on a segment 6, 4.

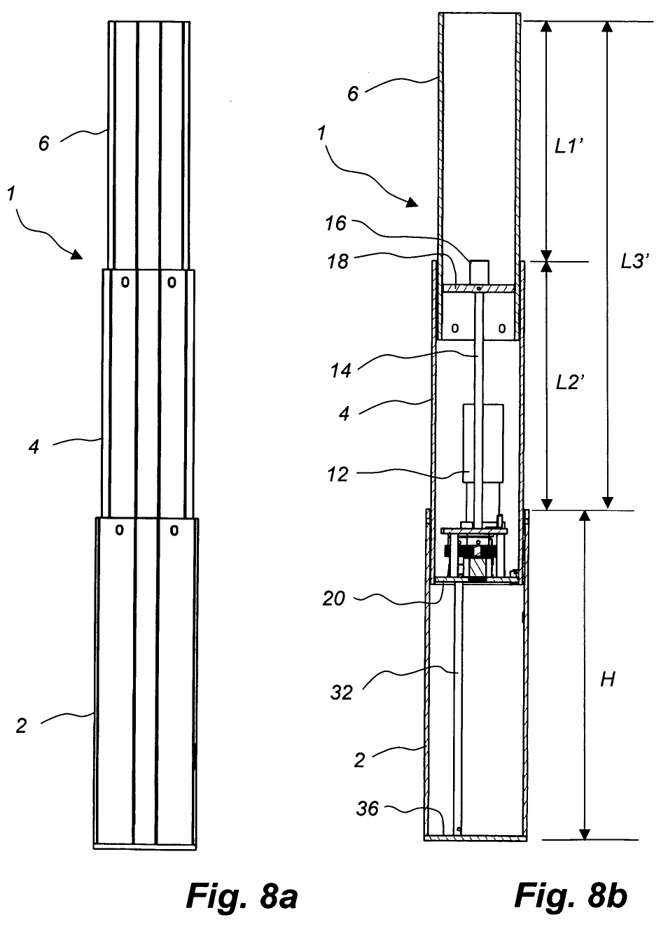

FIG. 8a shows the telescopic device 1 in its maximally extended telescoping position. As is evident from FIG. 8b which is a cross-section in the same telescoping position, the inner segment 6 has a very small overlap with the intermediate segment 4, which in turn has a very small overlap with the outer segment 2. According to the invention, it is thus possible to provide a telescopic device 1 which can be extended to a very great height and where the overlaps between the segments 2, 4, 6 largely coincide with the minimum overlaps that are required for strength reasons. In the maximally extended telescoping position shown in FIGS. 8a and 8b, the inner segment 6 has been telescoped a distance L1′ in relation to the intermediate segment 4 after the motor 12 has been in operation for a time t2. At the same time the intermediate segment 4 has been telescoped a distance L2′ in relation to the outer segment 2. Since the gear ratio of the transmission connection 46 is 1:1 as stated above and the threads of the rods 14, 32 have the same pitch, L1′ will be exactly the same as L2′. In the telescopic device 1, the inner segment 6 will thus always be telescoped exactly at the same time as the intermediate segment 4 and exactly to the same extent in relation to the intermediate segment 4 to which this is in turn telescoped in relation to the outer segment 2. As is evident from FIG. 8b, the inner segment 6 has been totally telescoped a distance L1′+L2′=L3′. The distance L3′ is about 1.5 times the height H of an individual segment 2, and thus the segments 2, 4, 6 are effectively utilised to provide a large working area of the telescopic device.

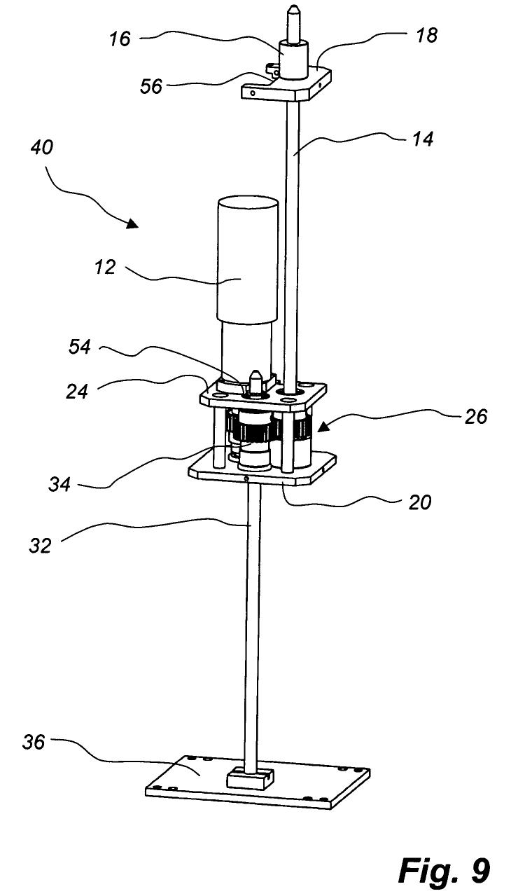

FIG. 9 illustrates the actuator 40 just before the completely extended position is achieved. As is evident from FIG. 9, the motor plate 24 has an opening 54, through which the second rod 32 extends out of the nut 34 (the rod 32 also extends through an opening, concealed in FIG. 9, in the base plate 20). Moreover the mounting plate 18 has a recess 56, which makes it possible for the plate 18 to be positioned parallel to the motor 12 in the telescoping position shown in FIG. 4.

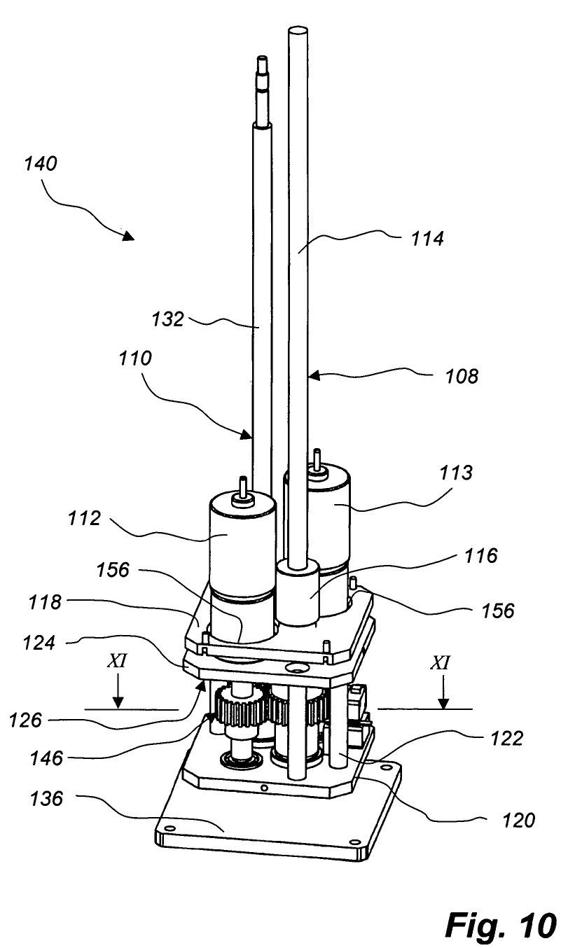

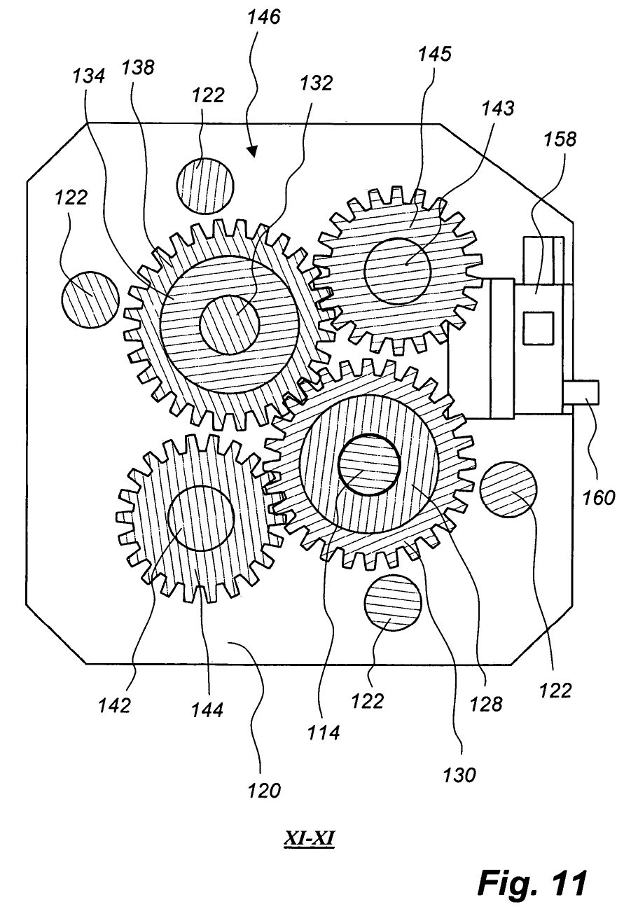

FIG. 10 shows an alternative embodiment of an actuator 140 for mounting in a telescopic device according to the invention. The actuator 140 has a first shifting device 108 which is essentially the same type as the shifting device 8 shown in FIGS. 1-9 and, thus, has a threaded first rod 114, which is rotatably mounted in a transmission case 126, and a first nut 116, which can be, for example, a threaded nut or a ball nut, which is fixedly connected to a mounting plate 118. The actuator 140 further has a second shifting device 110 which is essentially the same type as the shifting device 10 shown in FIGS. 1-9 and, thus, has a threaded second rod 132, which is fixedly connected to a supporting plate 136, and a second nut 134, which is shown in FIG. 11 and which, for example, can be a threaded nut or a ball nut and which is rotatably mounted in the transmission case 126. The transmission case 126 has a base plate 120 and, supported by struts 122, a motor plate 124. The actuator 140 shown in FIG. 10 has a first motor 112 and a second motor 113, which are attached to the motor plate 124. One reason why two or more motors can be convenient is that a plurality of motors involve redundancy, which gives increased safety, for example in nursing applications, such as hospital beds, examination tables, patient lifts etc. Safety can also relate to redundancy both with regard to the possibility of always being able to provide telescoping and with regard to the possibility of always ensuring braking of undesirable telescoping. Another reason can be that in certain applications it can be easier, for reasons of space, to mount two small motors instead of a single large motor. As is evident from FIG. 10, the mounting plate 118 has two holes 156, which allows the mounting plate 118 to pass the motors 112, 113 and be close to the motor plate 124.

FIG. 11 illustrates a transmission connection 146 which is included in the actuator 140 and is placed in the transmission case 126 shown in FIG. 10. The first rod 114 is mounted on a first shaft 128, to which a first gear rim 130 is attached. The second nut 134, which receives the second rod 132, has a second gear rim 138, which is in tooth engagement with the first gear rim 130. The first motor 112 is arranged to drive a second shaft 142, which supports a third gear rim 144, which is in tooth engagement with the first gear rim 130. The second motor 113 is arranged to drive a fourth shaft 143, which supports a fourth gear rim 145, which is in tooth engagement with the second gear rim 138. In operation, both motors 112, 113 will operate at exactly the same speed, since the gear rims 144, 145 have the same number of teeth and, via the gear rims 130, 138, are connected to each other. Thus the shifting devices 8, 10 will be driven exactly at the same time and, if the gear rims 130, 138 have the same number of teeth and the rods 114, 132 have the same pitch of the threads, provide exactly the same telescoping. Moreover, only one motor control is required, in FIG. 11 symbolised by a switch 158, to be able to control the actuator 140 since the minor variations in the performance of the motors 112, 113 that always occur will be eliminated by the transmission connection 146. The switch 158 will be activated when an inner segment (not shown in FIG. 11) comes into contact with its breaker plate 160, i.e. when the inner segment has reached its retracted telescoping position. At this moment also the intermediate segment (not shown in FIG. 11) will have reached its retracted telescoping position in relation to the outer segment. However, no additional switch to detect this is required since the transmission connection 146 ensures that the inner segment and the intermediate segment reach their respective retracted positions at exactly the same time. The two motors 112, 113 can either be designed so that each alone manages to drive the shifting devices 108, 110, thereby providing redundancy, or be designed so that the motors 112, 113 must operate together to manage this. The actuator 140 shown in FIGS. 10 and 11 has two motors 112, 113. It will be appreciated that it is possible to mount three, four or still more motors in an actuator and mechanically connect these motors, via a transmission connection, both to a first and to a second shifting device according to the principles described above.

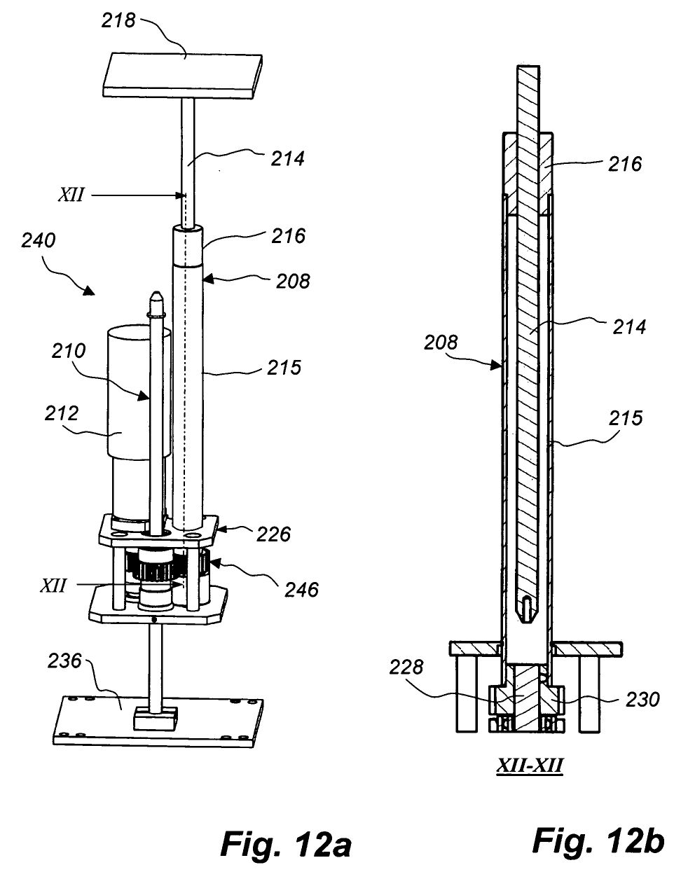

FIG. 12a illustrates an actuator 240 intended for a telescopic device according to a further alternative embodiment of the invention. The actuator 240 resembles the actuator 40 shown in FIG. 4, except for the design of a first shifting device 208. A second shifting device 210, a supporting plate 236 and a transmission case 226 are designed in the same way as the second shifting device 10, the supporting plate 36 and the transmission case 26, respectively, as described with reference to FIGS. 1-4, and will therefore not be described in more detail. The first shifting device 208 has a threaded first rod 214 which is fixedly connected to a mounting plate 218, which is adapted to be attached to the upper part of an inner segment (not shown in FIG. 12a) which is the same type as the inner segment 6 shown in FIGS. 1-3. The first shifting device 208 further comprises a first nut 216, which can be, for instance, a threaded nut or a ball nut, which is arranged to rotate about the first rod 214. A shaft 228 which is rotatably mounted in the transmission case 226 and shown in FIG. 12b and which via a first gear rim 230 is mechanically connected to the second shifting device 210 via a transmission connection 246 according to the principles described with reference to, inter alia, FIG. 6, transmits via a tube 215 rotation to the nut 216. As is best seen in FIG. 12b, the tube 215, which is fixedly connected to the nut 216 and to the shaft 228 and the first gear rim 230, has no contact with the first rod 214 and serves only as a way of transmitting rotation to the nut 216. When a motor 212 drives the transmission connection 246 mounted in the transmission case 226, the nut 216 will thus rotate and telescope the first rod 214 upwards together with the mounting plate 218 and the inner segment attached thereto, while at the same time also the second shifting device 210 is activated. The significant difference between the embodiment shown in FIGS. 12a and 12b and the one shown in FIGS. 1-4 thus is that in FIGS. 12a and 12b the first rod 214 is fixedly connected to the mounting plate 218 and cannot rotate.

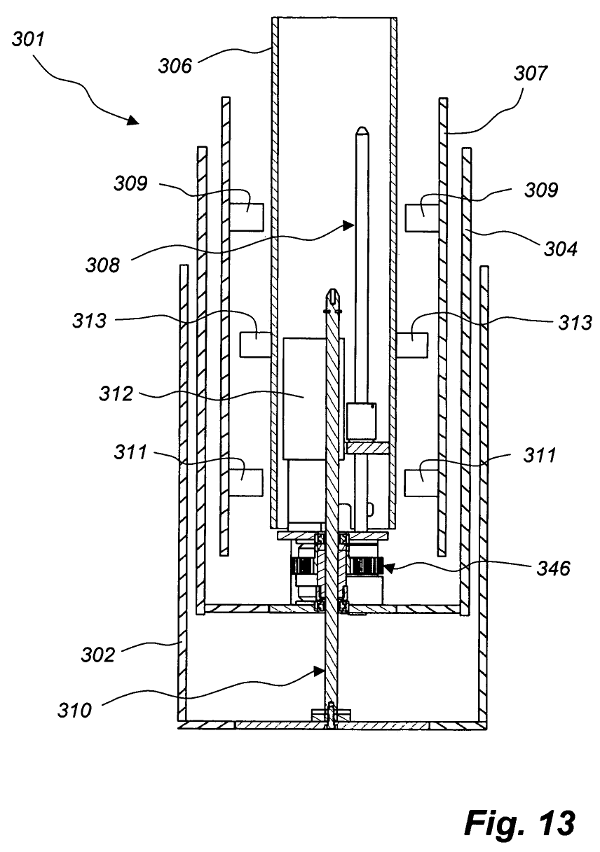

FIG. 13 illustrates a telescopic device 301 according to yet another embodiment of the invention. The telescopic device 301 has a first shifting device 308, which is adapted to telescope an inner segment 306 in relation to an intermediate segment 304, and a second shifting device 310, which is adapted to telescope the intermediate segment 304 in relation to an outer segment 302. The first and the second shifting device 308, 310 are driven by a motor 312 and are mechanically connected to each other by a transmission connection 346 in such a manner that they will always be activated simultaneously. The transmission connection 346 functions in the manner described above regarding the transmission connection 46 with reference to, inter alia, FIG. 6. A slave segment 307 is arranged inside the intermediate segment 304, but outside the inner segment 306. The slave segment 307, which thus is arranged between the inner segment 306 and the intermediate segment 304, is on its inside provided with upper lugs 309 and lower lugs 311. The inner segment 306 is on its outside provided with driver lugs 313, which are positioned between the upper and lower lugs 309, 311 of the slave segment 307. It will be appreciated that FIG. 13 is schematic for the purpose of illustration and that the lugs 309, 311, 313 are in reality significantly narrower and that the various segments 302, 304, 306, 307 are positioned closer to each other without gaps, or with narrow gaps only, between them. Thus, some friction will normally arise between the segments 302, 304, 306, 307. The purpose of the slave segment 307 is to increase the telescopic device's 301 resistance to lateral loads by providing an increased overlap of the segments 304, 306 and 307.

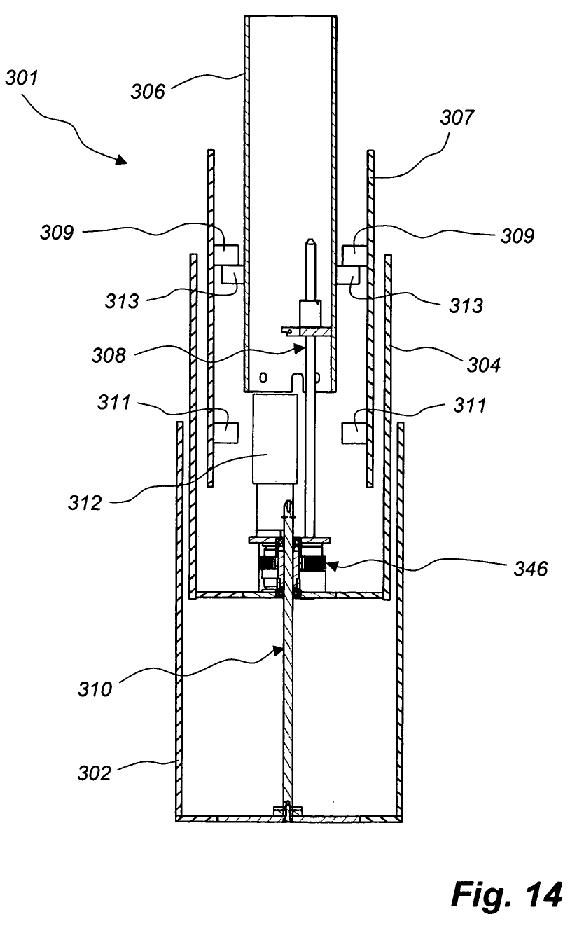

FIG. 14 shows the telescopic device 301 when the first shifting device 308 has telescoped the inner segment 306 in relation to the intermediate segment 304 while at the same time the second shifting device 310 has telescoped the intermediate segment 304 in relation to the outer segment 302. During this telescoping, the driver lugs 313 of the inner segment 306 have been brought into engagement with the upper lugs 309 of the slave segment 307 and pulled the slave segment 307 upwards. As is evident from FIG. 14, the segments 304, 306 and 307 will overlap each other to a great extent, which means that the telescopic device 301 will have great resistance to buckling and horizontal loads. When the telescopic device 301 is to be retracted again, the driver lugs 313 of the inner segment 306 will engage the lower lugs 311 of the slave segment 307 and thus pull the slave segment 307 downwards. This means that the slave segment 307, in spite of any friction against the intermediate segment 304, will be telescoped downwards.

It will be appreciated that the above-described invention can be modified within the scope of the appended claims.

It has been described above how gear rims are used to transmit rotation from a motor to the shifting devices 8, 10. It will be appreciated that this transmission can also be performed by other means, such as synchronous drive belts, chains or some other means which allow mechanically controlled transmission of rotation. Ordinary belts are less suited since they may cause slipping which decreases the check on where the individual segments are positioned.

Shifting devices with threaded rods have been described above. It will be appreciated that these rods can be, for example, rods with trapezoidal thread, along which nuts with trapezoidal thread are arranged to climb, ball screws along which ball nuts are arranged to climb, or some other suitable type of threaded rods. A further alternative is to design the rods as straight gear racks along which gear wheels are arranged to climb.

In the above-described telescopic device 1, the telescoping of the segment 6 in relation to the segment 4 occurs at the same speed as the telescoping of the segment 4 in relation to the segment 2. It will be appreciated that there may be cases where it is desirable to use different telescoping speeds, for instance if it is desirable that an inner segment not be extended as much as an intermediate segment for strength reasons. Such a wish can be complied with, for instance, by the rod 14 having a thread with a pitch other than that of the rod 32. Another option is to use a first gear rim 30 which has a number of teeth which is different from that of the second gear rim 38, which thus may give a gear ratio in the transmission connection of 1:1.5 or another suitable ratio. Also in such a case, the telescoping of the segments will, however, occur exactly at the same time. The ratio of how much the inner segment is telescoped in relation to the intermediate segment to how much the intermediate segment is telescoped in relation to the outer segment can thus be adjusted to the application in question and does not have to be 1:1. However the telescoping movements will always occur at the same time.

FIG. 6 shows how the first gear rim 30, which makes the first rod 14 rotate, is in direct tooth engagement with the second gear rim 38, which makes the second nut 34 rotate. An advantage of this is that the first rod 14 and the second rod 32 will be threaded in the same direction, for instance both rods 14, 32 are right-threaded, thus making it possible to reduce the number of spare parts in stock. However, it is also possible to design a transmission connection where the first and the second gear rim are in indirect tooth engagement with each other by one or more intermediate gear rims.

FIG. 11 indicates a switch 158 for checking when the inner segment, and thus also the intermediate segment, has reached its most retracted telescoping position. It will be appreciated that it is also possible instead to use a continuous position transducer for continuously checking the current degree of extension. Also in such a case, it is sufficient to have a single position transducer for checking where both the inner segment and the intermediate segment are located.

FIGS. 13 and 14 illustrate a slave segment 307 which is placed between the inner segment 306 and the intermediate segment 304. It is also possible to place a plurality of slave segments one inside the other and, by means of lugs on the outside and inside of the slave segments, make an inner segment pull these slave segments along while it is being telescoped. Of course, it is possible also, or instead, to use one or more slave segments placed between the outer segment and the intermediate segment and by means of lugs make the intermediate segment, while being telescoped, pull these along.

FIG. 1 etc. shows a telescopic device which is positioned on a surface, for instance a floor, and raises something. It is also possible instead to mount the telescopic device in a ceiling and use it to lower an object, for instance a light fitting, a surgical operating room lamp or the like. It is also possible to mount the telescopic device on a wall and use it to make something project horizontally from the wall.

Shifting devices 8, 10 having threaded rods 14, 32 have been described above. It is also possible to use chains, synchronous drive belts or like means in these positions in the shifting devices.

In the embodiment shown in FIGS. 1-9 the transmission connection 46, which is placed in the intermediate segment 4, is adapted to rotate the first rod 14 and the second nut 34 while the first nut 16 is fixed to the inner segment 6 and the second rod 32 is fixed to the outer segment 2. In the embodiment shown in FIG. 12a and FIG. 12b the transmission connection 246 is adapted to rotate the first nut 216 and the second nut 34 while the first rod 214 is fixed to the inner segment and the second rod 32 is fixed to the outer segment. It will be appreciated that other embodiments are possible as well. As one example the transmission connection could be adapted to rotate the second rod, in which case the second nut would be fixedly connected to the supporting plate of the outer segment (it will be appreciated that in such a case the second rod would have to be able to extend through the supporting plate of the outer segment). Since either the first nut or the first rod is adapted to be rotated, and either the second nut or the second rod is adapted to be rotated there are totally four ways of combining rotation/fixing of the nuts and rods. Further it is also not necessary to locate the transmission connection in the intermediate segment. Thus it is possible to locate the transmission connection in the outer segment or in the inner segment and arrange the rods and nuts accordingly. Placing the transmission connection in the intermediate segment is often preferred, however.

1. A telescopic device comprising:
an outer segment;
an intermediate segment;
an inner segment;
a first shifting device, adapted to telescope the inner segment in the intermediate, and including a threaded first rod and a first nut, movable along the first rod;
a second shifting device, adapted to telescope the intermediate segment in the outer segment, including a threaded second rod a second nut, movable along the second rod; and
a transmission connection placed in one of the segments, mechanically connecting the first and the second shifting device, the transmission connection being adapted to rotate one of the first rod and the first nut and simultaneously one of the second rod and the second nut, the other of the first rod and the first nut and the other of the second rod and the second nut each being fixedly connected to a segment separate from that segment in which the transmission connection is placed, the activation of one of the shifting devices causing simultaneous activation of the other shifting device and simultaneous telescoping of the intermediate segment in relation to the outer segment and of the inner segment in relation to the intermediate segment.

2. A telescopic device as claimed in claim 1, wherein the first rod is rotatably but axially non-displaceably connected to the intermediate segment and the first nut is fixedly connected to the inner segment, the second rod being fixedly connected to the outer segment and the second nut being rotatably but axially non-displaceably connected to the intermediate segment.

3. A telescopic device as claimed in claim 2, wherein the transmission connection includes a first gear rim fixedly connected to the first rod and a second gear rim fixedly connected to the second nut, the first and the second gear rim being arranged to be driven by a common motor in order to be able to rotate the first rod and the second nut.

4. A telescopic device as claimed in claim 3, wherein the first and the second gear rim are in tooth engagement with each other, and the motor is arranged to drive one of said gear rims.

5. A telescopic device as claimed in claim 1, wherein the first rod is fixedly connected to the inner segment and the first nut is rotatably but axially non-displaceably connected to the intermediate segment, the second rod being fixedly connected to the outer segment and the second nut being rotatably but axially non-displaceably connected to the intermediate segment, wherein an activation of any of the shifting devices makes the first nut and the second nut rotate.

6. A telescopic device as claimed in claim 1, wherein at least two motors are arranged to drive the transmission connection.

7. A telescopic device as claimed in claim 1, further comprising at least one slave segment, arranged between the inner segment and the intermediate segment or between the intermediate segment and the outer segment, said slave segment being arranged to be driven by the segment on the outside of which it is arranged.

8. A telescopic device as claimed in claim 1, wherein the transmission connection has such a gear ratio that the intermediate segment will be telescoped in relation to the outer segment at the same speed at which the inner segment will be telescoped in relation to the intermediate segment.

9. A telescopic device as claimed in claim 2, wherein at least two motors are arranged to drive the transmission connection.

10. A telescopic device as claimed in claim 3, wherein at least two motors are arranged to drive the transmission connection.

11. A telescopic device as claimed in claim 4, wherein at least two motors are arranged to drive the transmission connection.

12. A telescopic device as claimed in claim 5, wherein at least two motors are arranged to drive the transmission connection.

13. A telescopic device as claimed in claim 2, further comprising at least one slave segment, arranged between the inner segment and the intermediate segment or between the intermediate segment and the outer segment, said slave segment being arranged to be driven by the segment on the outside of which it is arranged.

14. A telescopic device as claimed in claim 3, further comprising at least one slave segment, arranged between the inner segment and the intermediate segment or between the intermediate segment and the outer segment, said slave segment being arranged to be driven by the segment on the outside of which it is arranged.

15. A telescopic device as claimed in claim 4, further comprising at least one slave segment, arranged between the inner segment and the intermediate segment or between the intermediate segment and the outer segment, said slave segment being arranged to be driven by the segment on the outside of which it is arranged.

16. A telescopic device as claimed in claim 5, further comprising at least one slave segment, arranged between the inner segment and the intermediate segment or between the intermediate segment and the outer segment, said slave segment being arranged to be driven by the segment on the outside of which it is arranged.

17. A telescopic device as claimed in claim 2, wherein the transmission connection has such a gear ratio that the intermediate segment will be telescoped in relation to the outer segment at the same speed at which the inner segment will be telescoped in relation to the intermediate segment.

18. A telescopic device as claimed in claim 3, wherein the transmission connection has such a gear ratio that the intermediate segment will be telescoped in relation to the outer segment at the same speed at which the inner segment will be telescoped in relation to the intermediate segment.

19. A telescopic device as claimed in claim 4, wherein the transmission connection has such a gear ratio that the intermediate segment will be telescoped in relation to the outer segment at the same speed at which the inner segment will be telescoped in relation to the intermediate segment.

20. A telescopic device as claimed in claim 5, wherein the transmission connection has such a gear ratio that the intermediate segment will be telescoped in relation to the outer segment at the same speed at which the inner segment will be telescoped in relation to the intermediate segment.
